(19) United States
(12) Patent Application Publication
(10) Pub. No.: US 2004/0043177 A1
(43) Pub. Date: Mar. 4, 2004

(54) Cover sheet package

(75) Inventor: Akira Mizuta, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/648,280

(22) Filed: Aug. 27, 2003

(30) Foreign Application Priority Data
Aug. 28, 2002 (JP) 2002-248044

(51) Int. Cl. B32B 9/00

(52) U.S. Cl. 428/40.1; 156/265

(57) ABSTRACT

A cover sheet package is structured so as to satisfy the relationship AP₁≦AP₂ where AP₁ indicates an adhesive force for adhering a peeling sheet to an adhesive film of a cover sheet and AP₂ indicates an adhesive force for adhering a protective sheet to a resin film of the cover sheet. This package allows peeling only the peeling sheet adhered to the adhesive film of the cover sheet when a peeling force acts upon one end portion of the peeling sheet, without peeling the protective sheet from the resin film the cover sheet.

### CROSS-REFERENCE TO RELATED APPLICATION

This application claims priority under 35 USC 119 from Japanese Patent Application No. 2002-248044, the disclosure of which is incorporated by reference herein.

### BACKGROUND OF THE INVENTION

1. Technical Field

The present invention relates to a cover sheet package that is structured such that a peeling sheet is adhered to an adhesive film of a cover sheet which is adhered to a disc substrate of an optical disk and a protective sheet is adhered to a resin film of the cover sheet.

2. Description of the Related Art

For example, a CD-R (Compact Disc-recordable), a CD (Compact Disc), a DVD (Digital versatile Disc) and a DVD-R (Digital Versatile Disc-recordable) have been already widely utilized as optical disk which records or plays back information by using laser light. Recently, there has been a demand for storing larger quantity of information such as image information for an optical disk, and thus study about an optical disk with high density has been proceeding. A recording density of such optical disk is almost determined by a spot size of optical beams on the disk. This spot size is in proportion to X/NA wherein X indicates a laser wavelength and NA indicates a numerical aperture. For this reason, in order to increase the recording density of the optical disk, laser light must have short wavelength and an objective lens must have increased NA. As a coma generated by an incline of the optical disk is increased in proportion to cube of NA, however, the margin of the incline of the disk is extremely decreased because of increased NA. As a result, a beam spot becomes blurred even by a little incline of the disk and thus recording and playing back with high density cannot be realized. Accordingly, in accordance with conventional optical disks which cope with high density, a cover layer serving as a transmitting layer for laser light must be sufficiently thin (e.g., about 0.1 mm) to suppress an increase in the coma caused by an incline of the disk due to increased NA. For example, see Japanese Patent Application Laid-Open (JP-A) No. 11-31337 (pp.9 to 10, FIG. 4).

In accordance with a process of manufacturing the above-described optical disk, for example, a thin film cover sheet formed of a resin film made of e.g., polycarbonate is adhered on a recording surface of a disk substrate at which an information recording layer is formed, and thus a transparent cover layer is formed on the disk substrate by this cover sheet. The cover sheet is formed by a resin film and an adhesive film which is formed on one side surface of the resin film, and adhered on the recording surface of the disk substrate via the adhesive film.

The above-described cover sheet is manufactured by working a laminated sheet material which has a four-layer structure comprised of an elongated band shaped resin film, an adhesive film formed on one side surface of the resin film, a peeling sheet adhered on the surface of the adhesive film so as to be peeled therefrom and a protective sheet adhered on the surface of the resin film so as to be peeled therefrom. Specifically, by punching the protective sheet, the resin film and the adhesive film of the laminated sheet material from the side of the protective sheet with a punching blade with annularly extending blade tip portion in a shape corresponding to the recording surface of the disk substrate, a cover sheet package formed by the cover sheet punched in a disk shape, the peeling sheet adhered to the cover sheet and the protective sheet is manufactured.

At this time, the peeling sheet adhered on the adhesive film of the cover sheet remains its elongated band shape without being punched by the punching blade. The elongated band shaped peeling sheet is used as a carrier base for conveying the cover sheet punched from the laminated sheet material. Namely, the cover sheet itself is extremely thin (e.g., 80 μm to 100 μm) and thus it is difficult for conveying the same without failures such as wrinkles being generated. Thus, by transmitting a conveyance force via the peeling sheet to the laminated sheet material with the peeling sheet being adhered to the cover sheet, the cover sheet can be easily conveyed without failures such as wrinkles being generated.

In accordance with the above-described cover sheet package, the peeling sheet is peeled from the adhesive film of the cover sheet immediately before the cover sheet is adhered to the disk substrate. Thus, it is possible to prevent foreign matters such as dusts from adhering to the adhesive film of the cover sheet or to prevent the adhesive film from being scratched before the cover sheet is adhered to the disk substrate. The protective sheet of the cover sheet package is usually peeled from the resin film of the cover sheet after the peeling sheet is peeled from the adhesive film. Consequently, it is possible to prevent the surface of the resin film serving as a laser light entering surface from being scratched when optical disks are manufactured.

The above-described conventional cover sheet package has been manufactured without especially considering the magnitude relationship between an adhesive force for adhering the peeling sheet to the adhesive film of the cover sheet and an adhesive force for adhering the protective sheet to the resin film of the cover sheet. Thus, if a peeling force is acted on the peeling sheet along its flexure direction in order to peel the peeling sheet from the cover sheet when the adhesive force of the peeling sheet with respect to the cover sheet is larger than that of the protective sheet, the peeling sheet is not peeled from the cover sheet and instead the cover sheet is curved. Then, end portions of the protective sheet may be locally peeled from this curved portion of the cover sheet. The protective sheet, once peeled from the cover sheet, cannot return to its original state of being adhered to the cover sheet with its original adhesive force or in a state of having been peeled from the cover sheet. This may cause various troubles at a time of manufacturing optical disks.

### SUMMARY OF THE INVENTION

The present invention was developed in view of the above-described facts. An object of the invention is to provide a cover sheet package in which only a peeling sheet can be reliably peeled without peeling a protective sheet from a resin film of a cover sheet when the peeling sheet is peeled from the cover sheet prior to the protective sheet.

A cover sheet package of a first aspect of the invention comprises a thin film cover sheet, a peeling sheet and a protective sheet. The thin film cover sheet includes a resin film, and an adhesive film is formed on one side surface of the resin film. The thin film cover sheet is adhered via the adhesive film to the recording surface of a disk substrate of an optical disk. The peeling sheet is peelably adhered on the surface of the adhesive film of the cover sheet and peeled before the cover sheet is adhered to the recording surface of the disk substrate. The protective sheet is adhered on the surface of the resin film of the cover sheet so as to be peeled. When an adhesive force for adhering the peeling sheet to the adhesive film of the cover sheet is indicated by AP₁ and an adhesive force for adhering the protective sheet to the resin film of the cover sheet is indicated by AP₁, the peeling sheet is adhered to the adhesive film of the cover sheet and the protective sheet is adhered to the resin film of the cover sheet so that the relationship AP₁≦AP₂ is satisfied.

In accordance with such cover sheet package of the invention, in order to peel the peeling sheet from the cover sheet prior to the protective sheet, a peeling force is acted upon one end portion of the peeling sheet adhered to the adhesive film of the cover sheet along its flexure direction. Then, a bending stress is generated at one end portion of the peeling sheet and the cover sheet.

At this time, if a sufficiently larger peeling force is applied to the peeling sheet when the stiffness (bending stiffness) of the cover sheet along its flexure direction is sufficiently larger than the adhesive force AP₁, the cover sheet itself is hardly curved and the bending stress of the peeling sheet generated by the peeling force becomes larger than the adhesive force AP₁. Then, the peeling sheet is smoothly peeled, against the adhesive force AP₁, from the adhesive film of the cover sheet from its one end portion toward its other end portion while being curved in a vicinity of a peeling point at which the peeling sheet is peeled from the adhesive film. If the bending stiffness of the cover sheet is not sufficiently larger than the adhesive force AP₁, sufficiently large peeling force is applied to the peeling sheet. Then, the cover sheet is curved with the peeling sheet. Nevertheless, in its flexure direction, a restoring force of the cover sheet increases as an amount of curve increases for the cover sheet having a characteristic of an elastic body. There comes a point where the total sum of the bending stress of the cover sheet generated by the restoring force and peeling force and the bending stress of the peeling sheet becomes larger than the adhesive force AP₁. At this point, while curved in a vicinity of the peeling point from the adhesive film at smaller curvature than that of the cover sheet, the peeling sheet is peeled, against the adhesive force AP₁, from the adhesive film of the cover sheet from its one end portion toward its other end portion. At the same time, the portion of the cover sheet that the peeling sheet has been peeled therefrom returns to its original configuration.

Accordingly, if the bending stiffness of the cover sheet is not sufficiently larger than the adhesive force AP₁, the cover sheet repeats its curving and restoring when the peeling sheet is peeled therefrom. When the cover sheet is curved, a bending stress is generated at the protective sheet adhered to the resin film. The bending stress of the protective sheet is smaller than that of the peeling sheet. Thus, the adhesive force AP₁ of the peeling sheet with respect to the cover sheet is set to be equal to or larger than the adhesive force AP₂ of the protective sheet. Then, even if the cover sheet is curved by a peeling force applied to the peeling sheet, only the peeling sheet adhered to the adhesive film of the cover sheet can be reliably peeled without peeling the protective sheet from the resin film of the cover sheet.

The strength of the adhesive force AP₁ of the peeling sheet with respect to the adhesive film of the cover sheet is generally influenced by an adhesive force of the adhesive film itself, materials for the peeling sheet and smoothness. If such conditions are constant, by appropriately selecting or adjusting type and composition of a peeling agent applied on the adhered surface of the peeling sheet, the adhesive force can be adjusted.

The strength of the adhesive force AP₂ of the protective sheet with respect to the resin film of the cover sheet is also generally influenced by materials for the resin film, materials for the protective sheet and smoothness. If such conditions are constant, by appropriately selecting or adjusting type and composition of an adhesive applied on the adhered surface of the protective sheet, the adhesive force can be adjusted.

### BRIEF DESCRIPTION OF THE DRAWINGS

FIG. 1 is a perspective view illustrating the structure of an optical disk manufactured by using a cover sheet package relating to embodiments of the present invention.

FIG. 2A is a perspective view illustrating the structure of a device for punching a laminated sheet material used for manufacturing the cover sheet package relating to the embodiments of the invention.

FIG. 2B is a side view illustrating the structure of the laminated sheet material used as a material for manufacturing the cover sheet package.

FIG. 3 is a side view illustrating the structure of a peeling device for peeling a peeling sheet from a cover sheet of the cover sheet package according to a first embodiment of the invention and conveying the cover sheet to a sheet conveying mount.

FIG. 4 is a side view illustrating the structure of a peeling device for peeling the peeling sheet from the cover sheet of the cover sheet package according to a second embodiment of the invention and conveying the cover sheet to the sheet conveying mount.

### DETAILED DESCRIPTION OF THE INVENTION

A cover sheet package relating to embodiments of the present invention will be described hereinafter with reference to the drawings.

(First Embodiment)

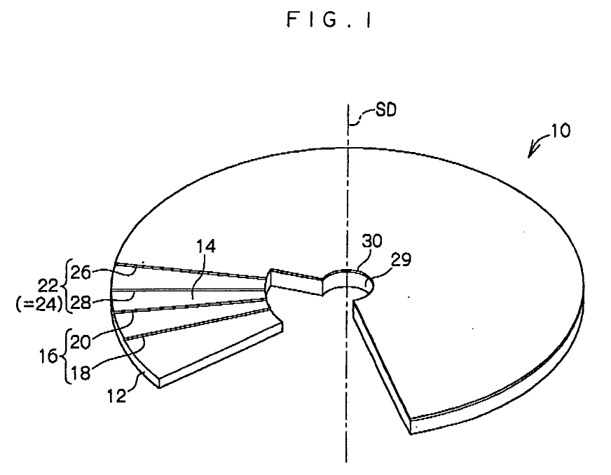

The structure of an optical disk manufactured by using a cover sheet package relating to the embodiments of the invention will be described with reference to FIG. 1. An optical disk 10 can record information with higher density as compared to a conventional optical disk, e.g., a DVD-R optical disk. For example, as compared to conventional optical disks, this optical disk 10 uses blue-violet laser light as laser light for recording and playing-back. Further, a numerical value NA of an objective lens of a record-and-playback device is increased to around 0.85. As a result, the single recording capacity of the optical disk 10 with a diameter of 12 cm is increased to 25 Gigabytes or more.

The optical disk 10 is provided with a disk substrate 12 formed in a disk configuration. An one side surface of the disk substrate 12 is an information recording surface 14. A light reflecting layer 18 and a light absorbing layer 20 are laminated in this order on the recording surface side of the disk substrate 12. The light reflecting layer 18 and the light absorbing layer 20 constitute an information recording layer 16. The information recording layer will be referred to as “a recording layer” hereinafter. The optical disk 10 is provided with a transparent cover layer 22 on the disk substrate 12 so as to cover the recording layer 16. This cover layer 22 is structured by a cover sheet 24 which is formed of a transparent resin film 26 and an adhesive film 28. The total thickness of such films is about 100 μm and may be about 110 μm.

The disk substrate 12 is obtained by molding, e.g., a polycarbonate (PC) resin. The cover sheet 24 constituting the cover layer 22 in the optical disk 10 uses, as a main material, a resin film 26 made of transparent resin such as PC, polyethylene terephthalate (PET). The adhesive film 28 is applied to an one side surface of the resin film 26 to a certain thickness. The adhesive film 28 is made of known adhesives such as acrylic, rubber and silicone adhesives. In view of transparency and durability, the adhesive film 28 made of acrylic adhesive is usually utilized.

A circular center hole 29 is formed at the central portion of the disk substrate 12 along a center of axis SD serving as the center of rotation for the optical disk 10. A circular opening portion 30 with the substantially same inner diameter as the center hole 29 is also formed at the central portion of the cover layer 22 with a center of axis S being the center. It is desirable that the inner peripheral edge of the cover layer 22 is positioned further toward the inner peripheral side than the recording layer 16 of the disk substrate 12. Within a range of satisfying such positional relationship, the inner diameter of the opening portion 30 may be larger than that of the center hole 29.

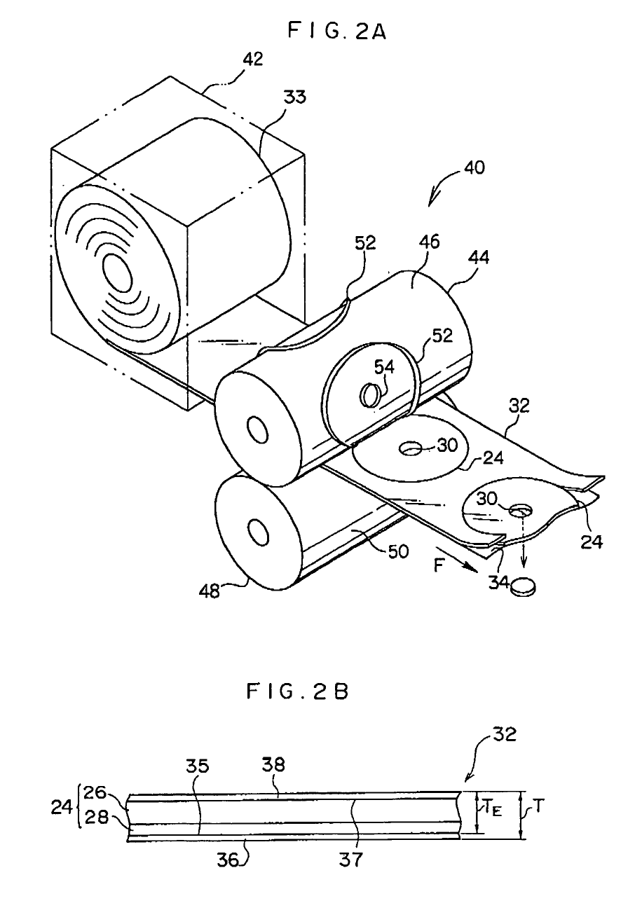

In a manufacturing line for the optical disk with the above-described structure, a manufacturing step for a disk substrate in which the recording layer 16 is formed at one side surface of the disk substrate 12 formed by molding and a molding step for a cover sheet in which a cover sheet package 34 is formed by a laminated sheet material 32 (see FIG. 2B) are performed independently. The disk substrate 12 and the cover sheet 24 are manufactured by such steps. Then, the cover sheet 24 is adhered onto the disk substrate 12 in an adhering step, so that the optical disk 10 shown in FIG. 1 is manufactured.

The cover sheet package 34 relating to the first embodiment of the invention is manufactured by using the laminated sheet material 32 shown in FIG. 2B. The laminated sheet material 32 has a four-layer structure formed of the resin film 26, the adhesive film 28 formed on the one side surface of the resin film 26, a peeling sheet 36 adhered onto the surface of the adhesive film 28 and a protective sheet 38 adhered to the surface of the resin film 26 opposite the surface on which the adhesive film 28 is provided. The peeling sheet 36 and the protective sheet 38 are respectively formed in a thin film by molding, e.g. a PET resin. A peeling agent mainly made of siliconee is applied on an adhered surface 35 for the peeling sheet 36 in order to accomplish excellent peeling property. An adhesive mainly made of vinyl acetate is applied onto an adhered surface 37 for the protective sheet 38 to maintain adhesion with the resin film 26.

As shown in FIG. 2A, the laminated sheet material 32 is formed in an elongated band shape and supplied into a manufacturing line for optical disk as a sheet roll 33 taken up in a roll. In accordance with the manufacturing line for optical disk, the sheet roll 33 is loaded into a feeding section 42 in a punching device 40 and rotatably supported by this feeding section 42. The punching device 40 is provided a pair of blade roller 44 and receiving roller 48. A plurality of (e.g., three) outer peripheral punching blades 52 and inner peripheral punching blades 54 are concentrically provided at a roller surface 46 of the blade roller 44 along its peripheral direction. The receiving roller 48 is disposed under the blade roller 44 so as to be axially parallel to the same. These rollers 44 and 48 receive torque from an unillustrated roller driving section and are rotated at equal linear velocity.

The outer peripheral punching blade 52 of the blade roller 44 is annularly provided on the roller surface 46. When developed onto a plane, the outer peripheral punching blade is formed so that its blade tip portion extends along a circular locus with substantially the same diameter as the disk substrate 12 or with a diameter which is smaller than that of the disk substrate 12. The length the outer peripheral punching blade 52 protruding from the roller surface 46 is set to be equal to or little longer than a thickness T_{E} (see FIG. 2B) from the surface of the protective sheet 38 to the adhered surface 35 for the peeling sheet 36 in the laminated sheet material 32. Thus, the tip of the outer peripheral punching blade 52 reaches in a vicinity of the intermediate in the thickness of the peeling sheet 36 and an elastic deformed portion of the laminated sheet material 32 is absorbed. As a result, the protective sheet 38 and the resin film 26 can be reliably cut.

The inner peripheral punching blade 54 of the blade roller 44 is also annularly provided on the roller surface 46. When developed onto a plane, the inner peripheral punching blade 54 is formed so that its blade tip portion extends along a circular locus with substantially the same diameter as the opening portion 30 (see FIG. 1) of the cover sheet 24. The length the inner peripheral punching blade 54 protruding from the roller surface 46 is set to be equal to a total thickness T (see FIG. 2B) of the entire laminated sheet material 32 or to be shorter than the thickness T when taking compression deformation of the laminated sheet material 32 at a time of punching into consideration.

The roller surface 50 of the receiving roller 48 is formed of a curved surface with a constant radius of curvature from the center of its shaft and is made of materials such as metals and hard resins having a predetermined or higher hardness and wear resistance. The receiving roller 48 is urged with a predetermined urging force toward the blade roller 44 by an unillustrated urging mechanism.

In the punching device 40, the laminated sheet material 32 is fed from the sheet roll 33 loaded into the feeding section 42 toward between the blade roller 44 and the receiving roller 48. Then, the laminated sheet material 32 is nipped by the rolls 44 and 48. The blade roller 44 and receiving roller 48 rotate at equal linear velocity to feed the laminated sheet material 32 toward the downstream side. While being pressed (compressed) between the roller surface 46 of the blade roller 44 and the roller surface 50 of the receiving roller 48 as the receiving roller 48 is urged by the urging mechanism, the laminated sheet material 32 is conveyed in a conveyance direction (i.e., a direction indicated by the arrow F) at a constant speed by a conveyance force from the rollers 44 and 48. When the laminated sheet material 32 is conveyed by the rolls 44 and 48, the blade roller 44 makes its roll surface 46 press-contact the surface of the protective sheet 38. The receiving roller 48 makes its roll surface 50 press-contact the surface of the peeling sheet 36.

While conveying the laminated sheet material 32 together with the receiving roller 48 in the conveyance direction, the blade roller 44 presses the outer peripheral punching blade 52 against the protective sheet 38 of the laminated sheet material 32. Then, the laminated sheet material 32 is cut by the outer peripheral punching blade 52 and the inner peripheral punching blade 54. The length that the outer peripheral punching blade 52 protrudes from the roller surface 46 is set to be equal to or little longer than the thickness T_{E} (see FIG. 2B) of the laminated sheet material 32. Thus, the outer peripheral punching blade 52 penetrates the protective sheet 38 and the resin film 26 with the adhesive film 28 being formed on its one side surface in the laminated sheet material 32 but not the peeling sheet 36. Portions of the protective sheet 38 and the resin film 26 in the laminated sheet material 32 that has passed between the rollers 44 and 48 that are at the inner peripheral side of the outer peripheral punching blade 52 are punched in a disk configuration and separated from other portions. The peeling sheet 36 of the laminated sheet material 32 which has passed between the rollers 44 and 48 retains its elongated band shape and is fed in the conveyance direction without being punched by the rollers 44 and 48.

The length that the inner peripheral punching blade 54 protrudes from the roller surface 46 is set to be equal to or a little shorter than the thickness T (see FIG. 2B) in the laminated sheet material 32. Thus, the inner peripheral punching blade 54 penetrates the entire laminated sheet material 32 and forms a circular through hole at the central portion of the portion of the laminated sheet material 32 punched by the outer peripheral punching blade 52. The resin film 26 and the adhesive film 28 punched in a disk shape by the outer peripheral punching blade 52 constitute the cover sheet 24 to be adhered to the disk substrate 12. The through hole formed by punching the resin film 26 and the adhesive film 28 with the inner peripheral punching blade 54 serves as the opening portion 30 of the cover sheet 24. The cover sheet 24 is fed in the conveyance direction with the peeling sheet 36 which is punched by the outer peripheral punching blade 52 and the inner peripheral punching blade 54 to have the same surface configuration as the cover sheet 24 being adhered thereto.

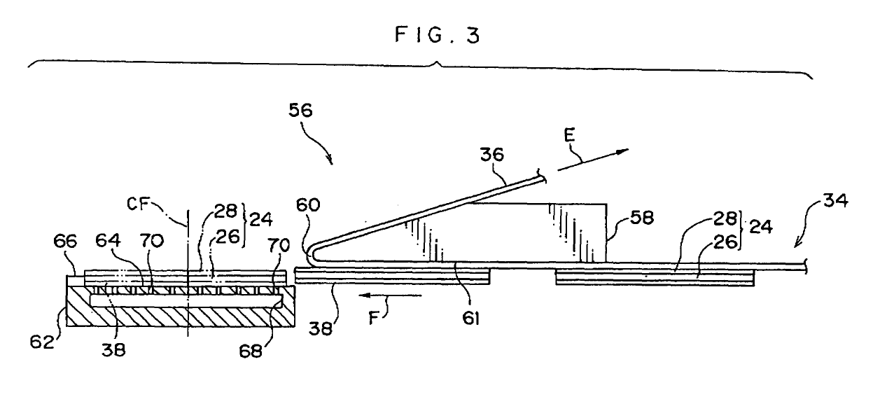

Next, in the punching device 40, portions of the peeling sheet 36 and the resin film 26 at the outer peripheral side of the cover sheet 24 are peeled from the laminated sheet material 32 which has passed between the blade roller 44 and the receiving roller 48 and removed therefrom. Further, the portion of the laminated sheet material 32 at the inner peripheral side of the opening portion 30 is punched and removed. Thus, the cover sheet package 34 (see FIG. 3) in which the peeling sheet 36 is adhered to the adhesive film 28 of the cover sheet 24 and the protective sh et 38 is adhered to the resin film 26 is manufactured. In accordance with this cover sheet package 34, the peeling sheet 36 with the elongated band shape is adhered to the adhesive film 28 of the cover sheet 24. The protective sheet 38 has the same surface configuration as the cover sheet 24 and is adhered to the resin film 26.

In the cover sheet package 34, assume that an adhesive force for adhering the peeling sheet 36 to the adhesive film 28 of the cover sheet 24 is indicated by AP₁ and an adhesive force for adhering the protective sheet 38 to the resin film 26 of the cover sheet 24 is indicated by AP₂. Then, the peeling sheet 36 is adhered via a peeling agent to the adhesive film 28 of the cover sheet 24 and the protective sheet 38 is adhered via a vinyl acetate adhesive to the resin film 26 of the cover sheet 24 so that the relationship AP₁≦AP₂ is satisfied.

The strength of the adhesive force AP₁ for the peeling sheet 36 is generally influenced by the adhesive force of the adhesive film 28 itself, materials for the peeling sheet 36 and smoothness of the adhered surface 37. If such conditions are constant, the strength of the adhesive force AP₁ can be adjusted by appropriately selecting or adjusting the composition of a peeling agent (e.g., a silicone peeling agent) applied to the adhered surface 37 of the peeling sheet 36. Also, the strength of the adhesive force AP₂ for the protective sheet 38 is generally influenced by materials for the resin film 26, materials for the protective sheet 38 and smoothness of the adhered surface 37. If such conditions are constant, the strength of the adhesive force AP₂ can be adjusted by appropriately selecting or adjusting the composition of an adhesive (e.g., a vinyl acetate adhesive) applied onto the adhered surface 37 of the protective sheet 38.

As shown in FIG. 3, the manufacturing line for optical disk is provided with a sheet peeling device 56 for peeling the peeling sheet 36 from the cover sheet 24 of the cover sheet package 34 and conveying the cover sheet 24 from the punching device 40 to a sheet conveying mount 62. A wedge-shaped peeling guide member 58 for peeling the peeling sheet 36 from the cover sheet package 34 is disposed at the sheet peeling device 56. The peeling guide member 58 is supported so that its distal end portion 60 is directed to the side of the sheet conveying mount 62.

Further, the sheet peeling device 56 is provided with an unillustrated tension mechanism that applies a tensile force in a predetermined peeling direction (i.e., a direction indicated by the arrow E) to the peeling sheet 36 of the cover sheet package 34 while applying a certain tension to the peeling sheet 36. Thus, in the sheet peeling device 56, the peeling sheet 36 of the cover sheet package 34 is moved from the proximal end side of the peeling guide member 58 to the distal end side thereof while being press-contacted with the bottom surface 61 and the distal end portion 60 of the peeling guide member 58 at a certain press-contact force. At this time, in a vicinity of the distal end portion 60 of the peeling guide member 58, the peeling sheet 36 adhered to the cover sheet 24 is pulled upward along the distal end portion 60 so as to be peeled from the cover sheet 24. The cover sheet 24 with the peeling sheet 36 having been peeled is pressed forward from the distal end portion 60 of the peeling guide member 58 by a tensile force from the tension mechanism being transmitted thereto via the peeling sheet 36. As a result, the cover sheet 24 is slid onto the sheet conveying mount 62 held at a waiting position shown in FIG. 3.

As shown in FIG. 3, the top surface of the sheet conveying mount 62 is a flat sheet mounting surface 64. A protruded stopper member 66 is disposed on the conveyance direction end portion of the sheet mounting surface 64. The stopper member 66 abuts the outer peripheral edge of the cover sheet 24 slid onto the sheet mounting surface 64 to stop the cover sheet 24. At this time, the cover sheet 24 is positioned at the central position of the sheet mounting surface 64 so that its center coincides the center CF of the sheet mounting surface 64. A negative pressure chamber 68 is provided under the sheet mounting surface 64 within the sheet conveying mount 62. A plurality of suction holes 70 are formed so as to penetrate from the negative pressure chamber 68 to the sheet mounting surface 64.

The negative pressure chamber 68 is connected to an unillustrated vacuum generating device such as a vacuum pump. The vacuum generating device supplies a negative pressure within the negative pressure chamber 68 in cooperation with the cover sheet 24 being positioned onto the central position on the sheet mounting surface 64. Thus, the cover sheet 24 is held on the sheet mounting surface 64 by the action of negative pressure from the suction holes 70 when a negative pressure is supplied within the negative pressure chamber 68.

The manufacturing line for optical disk comprises a sheet conveying device for conveying the cover sheet 24 disposed on the sheet conveying mount 62. When the cover sheet 24 is placed on the sheet conveying mount 62 at the waiting position, the sheet conveying device conveys the cover sheet 24 together with the sheet conveying mount 62 from the waiting position to an adhering device (not shown) at which the cover sheet 24 is adhered to the disk substrate and moves the cover sheet 24 from the sheet conveying mount 62 to the adhering device. When the sheet conveying device moves the cover sheet 24 from the sheet conveying mount 62 to the adhering device, the sheet conveying mount 62 is returned to the waiting position.

The vacuum generating device continues to supply a negative pressure within the negative pressure chamber 68 until just before of the cover sheet 24 is moved from the sheet conveying mount 62 to the adhering device. During conveyance from the waiting position to the adhering device by the sheet conveying device, the cover sheet 24 is conveyed to the adhering device without being deviated from the central position of the sheet mounting surface 64 nor fallen therefrom due to influences of vibration, inertia and incline of the sheet mounting surface 64. In the adhering device, under vacuum, the disk substrate 12 (see FIG. 1) is placed on the cover sheet 24 placed on a support table with the adhesive film 28 being faced upward. Then, the disk substrate 12 is pressed from upward. AS a result, the disk substrate 12 is adhered to the cover sheet 24 and thus the optical disk 10 is manufactured as a product.

Next, the operation of the cover sheet package 34 relating to this embodiment used for manufacturing the above-described optical disk 10 will be described.

In accordance with the cover sheet package 34 relating to this embodiment, assume that an adhesive force for adhering the peeling sheet 36 to the adhesive film 28 of the cover sheet 24 is indicated by AP₁ and an adhesive force for adhering the protective sheet 38 to the resin film 26 of the cover sheet 24 is indicated by AP₂. Then, the peeling sheet 36 is adhered to the adhesive film 28 of the cover sheet 24 and the protective sheet 38 is adhered to the resin film 26 of the cover sheet 24 so that the relationship AP₁≦AP₂ is satisfied.

In the above-described cover sheet package 34, in order to peel the peeling sheet 36 from the cover sheet 24 prior to the protective sheet 38, a peeling force acts along a flexure direction upon one end portion of the peeling sheet 36 adhered to the adhesive film 28 of the cover sheet 24. Then, a bending stress is generated at one end portion of the peeling sheet 36 and the cover sheet 24.

When the stiffness (bending stiffness) of the cover sheet 24 along its flexure direction is sufficiently larger than the adhesive force AP₁, the cover sheet 24 itself is little curved even if sufficiently large peeling force is applied to the peeling sheet 36 and thus the bending stress of the peeling sheet 36 generated by the peeling force is larger than the adhesive force AP₁. While curved in a vicinity of a peeling point at which the peeling sheet 36 is peeled from the adhesive film 28, the peeling sheet 36 is smoothly peeled, against the adhesive force AP₁, from the adhesive film 28 of the cover sheet 24 from its one end portion toward its other end portion.

When the bending stiffness of the cover sheet 24 is not much larger than the adhesive force AP₁, by applying sufficiently large peeling force to the peeling sheet 36, the cover sheet 24 is curved with the peeling sheet 36. In the flexure direction, as an amount of curve for the cover sheet 24 with a characteristic of an elastic body is increased, its restoring force is also increased. When the total sum of the bending stress of the cover sheet 24 caused by the restoring force and the peeling force and the bending stress of the peeling sheet 36 becomes larger than the adhesive force AP₁, the peeling sheet 36 is peeled, against the adhesive force AP₁, from the adhesive film 28 of the cover sheet 24 from its one end portion toward its other end portion while curved at smaller curvature than that of the cover sheet 24 in a vicinity of the point of being peeled from the adhesive film 28. At the same time, the portion of the cover sheet 24 that the peeling sheet 36 has been peeled returns to its original configuration.

Accordingly, if the bending stiffness of the cover sheet 24 is not sufficiently larger than the adhesive force AP₁, the cover sheet 24 repeats curving and restoring when the peeling sheet 36 is peeled. If the cover sheet 24 is curved, a bending stress generates at the protective sheet 38 adhered to the resin film 26. The bending stress generated at the protective sheet 38 is smaller than that of the peeling sheet 36. Thus, the adhesive force AP₁ of the peeling sheet with respect to the cover sheet 24 is set to be equal to or larger than the adhesive force AP₂ of the protective sheet 38. Then, even if the cover sheet 24 is curved by a peeling force applied to the peeling sheet 36, the protective 38 is not peeled from the resin film 26 of the cover sheet 24. Consequently, only the peeling sheet 36 adhered to the adhesive film 28 of the cover sheet 24 can be reliably peeled.

In accordance with the optical disk 10 with high information recording density relating to this embodiment, the thickness of the cover sheet 24 is desirably as thin as possible. For this reason, the thickness of the cover sheet 24 in the cover sheet package 34 is thin such as about 80 μm to 100 μm and its bending stiffness is also small.

Thus, in accordance with the cover sheet package 34 used for manufacturing the optical disk 10, it is usually difficult to make the bending stiffness of the cover sheet 24 be sufficiently larger than the adhesive force AP₁. By satisfying the relationship AP₁≦AP₂, only the peeling sheet 36 adhered to the adhesive film 28 of the cover sheet 24 can be reliably peeled by using the sheet peeling device 56 without peeling the protective sheet 38 from the cover sheet 24.

The adhesive force AP₁ for adhering the peeling sheet 36 to the adhesive film 28 must be large to a certain extent in order to prevent the peeling sheet 36 from being peeled or deviated from the cover sheet 24 when the laminated sheet material 32 is punched by the punching device 40 or conveyed by the sheet peeling device 56. If the adhesive force AP₂ for adhering the protective sheet 38 to the resin film 26 is excessively large, the workability for peeling the protective sheet 38 from the resin film 26 of the cover sheet 24 is decreased. Alternatively, the large adhesive force AP₂ causes damage such as deformation of the cover sheet 24 when the protective sheet 38 is peeled from the resin film 26 of the cover sheet 24. By taking such factor into consideration, in accordance with the cover sheet package 34 relating to this embodiment, the adhesive force AP₁ is set to be a value selected from the range of 5 to 50 (gf/cm). At the same time, the adhesive force AP₂ is set to be a value selected from the range of (AP₁×1.0) to (AP₁×3.0). For the adhesive forces AP₁ and AP₂, values measured by a 90′ peeling method defined in JIS Z 1528 (one of the Japanese Industrial Standards corresponding to ICS 83.180) are used.

(Second Embodiment)

Next, a cover sheet package relating to a second embodiment of the invention will be described. Among members of this embodiment, the same members as in the first embodiment will be denoted by the same reference numerals and descriptions thereof will be omitted.

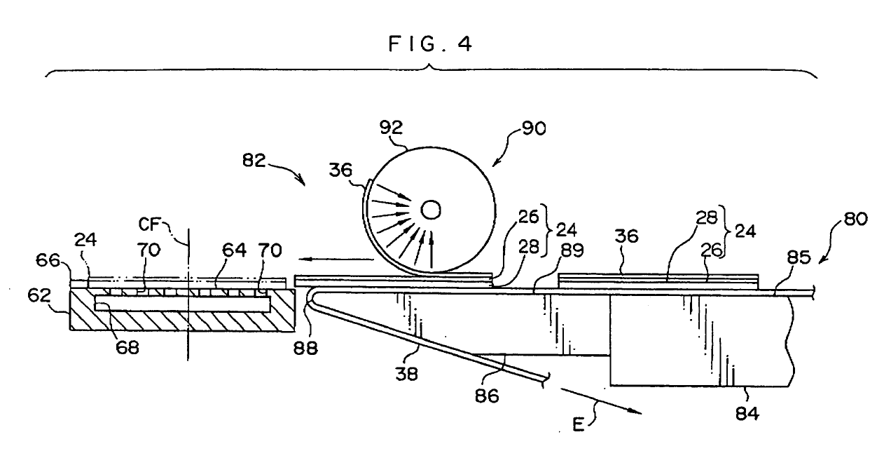

A cover sheet package 80 relating to the second embodiment of the invention is manufactured from the laminated sheet material 32 as the cover sheet package 34 relating to the first embodiment. The cover sheet package 80 of this embodiment is different from the cover sheet package 34 in that the protective sheet 38 is replaced with the peeling sheet 36. Namely, as shown in FIG. 4, the protective sheet 38 remains its elongated band shape without being cut by the punching device 40, and the peeling sheet 36 is punched in the same surface configuration as the cover sheet 24 (i.e., in a disk configuration).

The above-described cover sheet package 80 can be manufactured by turning the laminated sheet material 32 upside down so that the directions the protective sheet 38 and the peeling sheet 36 are faced are inverted as compared to the case of the cover sheet package 34 when the cover sheet 24 is punched from the laminated sheet material 32 by the punching device 40 shown in FIG. 2A, and then feeding the laminated sheet material 32 between the blade roller 44 and the receiving roller 48, for example. Alternatively, the cover sheet package 80 may be manufactured in such a manner that the directions the protective sheet 38 and the peeling sheet 36 are faced are not inverted, instead the blade roller 44 is replaced with the receiving roller 48 in the punching device 40, and the laminated sheet material 32 is fed between these rollers 44 and 48.

The protective sheet 38 which remains its elongated band shape serves as a carrier base for conveying the cover sheet 24 of the cover sheet package 80. As the cover sheet package 34 relating to the first embodiment, in the cover sheet package 80, assume that an adhesive force for adhering the peeling sheet 36 to the adhesive film 28 of the cover sheet 24 is indicated by AP₁ and an adhesive force for adhering the protective sheet 38 to the resin film 26 of the cover sheet 24 is indicated by AP₂. Then, the peeling sheet 36 is adhered via a peeling agent to the adhesive film 28 of the cover sheet 24 and the protective sheet 38 is adhered via a vinyl acetate adhesive to the resin film 26 of the cover sheet 24 so that the relationship AP₁≦AP₂ is satisfied.

As shown in FIG. 4, a manufacturing line for optical disk is provided with a sheet peeling device 82 which peels the protective sheet 38 and the peeling sheet 36 from the cover sheet 24 of the cover sheet package 80 and conveys the cover sheet 24 from the punching device 40 to the sheet conveying mount 62.

The sheet peeling device 82 is provided with a slide table 84 for guiding the cover sheet 24 of the cover sheet package 80 on the sheet conveying mount 62 and a wedgeped shaped peeling guide member 86 extending from the slide table 84 toward the side of the sheet conv ying mount 62. The top surface portion of the slide table 84 is a slide surface 85 formed of smooth flat surface. The cover sheet 24 is placed on the slide surface 85 with its peeling sheet 36 being faced upward.

The top surface portion 89 of the peeling guide member 86 abuts the cover sheet 24 via the protective sheet 38 of the cover sheet package 80. This top surface portion 89 is supported so as to be substantially flush with the slide surface 85 of the slide table 84. The cover sheet 24 which has been conveyed on the slide surface 85 is placed on the top surface portion 89 of the peeling guide member 86. Then, under this state, a tensile force is applied to the protective sheet 38 in a peeling direction (i.e., a direction indicated by the arrow E) in order to peel the protective sheet 38 from the cover sheet 24 along the distal end portion of the peeling guide member 86. As a result, the portion of the cover sheet 24 that the protective sheet 38 as been peeled therefrom is slid from the peeling guide member 86 to the sheet conveying mount 62.

As shown in FIG. 4, a suction roller 90 is rotatably supported at the sheet peeling device 82 so as to be above of the peeling guide member 86 and be further toward the upstream side than the distal end portion 88 of the peeling guide member 86. A plurality of suction hol s (not shown) for supplying a negative pressure from outside of the roller are open on the roller surface 92 of the suction roller 90. The suction roller 90 is rotated in accordance with the cover sheet 24 while its roller surface 92 is press-contacting the peeling sheet 36 adhered to the adhesive film 28 of the cover sheet 24. The peeling sheet 36 is peeled from the adhesive film 28 of the cover sheet 24 by a suction force from the suction roller 90 before the protective sheet 38 is peeled from the cover sheet 24 and then moved on the roller surface 92 of the suction roller 90. The peeling sheet 36 is peeled from the roller surface 92 and recovered in a recovery container (not shown).

The cover sheet 24 that the peeling sheet 36 and the protective sheet 38 have been peeled therefrom abuts the stopper member 66 on the sheet mounting surface 64 of the sheet conveying mount 62, is positioned so that its center coincides the center CF of the sheet mounting surface 64 and sucked on the sheet mounting surface 64 by the action of a negative pressure from the suction holes 70 which are communicated with the negative pressure chamber 68. Then, the sheet conveying device in the manufacturing line for optical disk conveys the cover sheet 24 together with the sheet conveying mount 62 from a waiting position to an adhering device (not shown) for adhering to a disk substrate. Namely, the cover sheet 24 is moved from the sheet conveying mount 62 to the adhering device. After the cover sheet 24 is moved from the sheet conveying mount 62 to the adhering device, the sheet conveying device returns the sheet conveying mount 62 to its waiting position. In the adhering device, under vacuum, the disk substrate 12 (see FIG. 1) is placed on the cover sheet 24 placed on a support table so that its adhesive film 28 is faced upward. Then, the disk substrate 12 is pressed from upward, so that the disk substrate 12 is adhered to the cover sheet 24. As a result, the optical disk 10 is manufactured as a product.

Next, the operation of the cover sheet package 80 used for manufacturing the optical disk 10 as described above in accordance with this embodiment will be described.

As in the cover sheet package 34 relating to the first embodiment, in accordance with the cover sheet package 80 relating to this embodiment, assume that an adhesive force for adhering the peeling sheet 36 to the adhesive film 28 of the cover sheet 24 is indicated by AP₁ and an adhesive force for adhering the protective sheet 38 to the resin film 26 of the cover sheet 24 is indicated by AP₂. The peeling sheet 36 is adhered to the adhesive film 28 of the cover sheet 24 and the protective sheet 38 is adhered to the resin film 26 of the cover sheet 24 so that the relationship AP₁≦AP₂ is satisfied. Thus, even if the bending stiffness of the cover sheet 24 of the cover sheet package 80 cannot be sufficiently larger than the adhesive force AP₁, only the peeling sheet 36 can be reliably peeled from the adhesive film 28 of the cover sheet 24 by using the sheet peeling device 82 without peeling the protective sheet 38 from the cover sheet 24 and then the protective sheet 38 can be peeled from the portion of the cover sheet 24 that the peeling sheet 36 has been peeled therefrom.

Only the case of peeling the peeling sheet 36 from the cover sheet 24 of the cover sheet package 34, 80 by the sheet peeling device 56, 82 has been described in the present embodiments. Nevertheless, in accordance with the cover sheet package 34, 80 relating to the present embodiments, the effect can be obtained that when the peeling sheet 36 is peeled from the cover sheet 24 prior to the protective sheet 38 manually or by using sheet peeling devices other than the sheet peeling device 56, 82, only the peeling sheet 36 can be reliably peeled from the adhesive film 28 of the cover sheet 24 without peeling the protective sheet 38 of the cover sheet package 34, 80 from the cover sheet 24.

As described above, in accordance with a cover sheet package of the invention, when a peeling sheet is peeled from a cover sheet prior to a protective sheet, only the peeling sheet can be reliably peeled without peeling the protective sheet from a resin film of the cover sheet.

What is claimed is:

1. A cover sheet package comprising:
a thin film cover sheet including a resin film, the thin film cover sheet having an adhesive film formed on one side surface of the resin film, and which is adhered via the adhesive film to a recording surface of a disk substrate of an optical disk;
a peeling sheet which is peelably adhered on a surface of the adhesive film of the cover sheet and which is peeled before the cover sheet is adhered to the recording surface of the disk substrate; and
a protective sheet which is peelably adhered on a surface of the resin film of the cover sheet,
wherein, when an adhesive force for adhering the peeling sheet to the adhesive film of the cover sheet is indicated by AP₁ and an adhesive force for adhering the protective sheet to the resin film of the cover sheet is indicated by AP₂, the peeling sheet is adhered to the adhesive film of the cover sheet and the protective sheet is adhered to the resin film of the cover sheet so that the relationship AP₁≦AP₂ is satisfied.

2. A cover sheet package according to claim 1, wherein the adhesive force AP₁ is set to be a value selected from a range of 5 to 50 (gf/cm), and the adhesive force AP₂ is set to be a value selected from a range of (AP₁×1.0) to (AP₁×3.0).

3. A cover sheet package according to claim 2, wherein a total thickness of the cover sheet, the resin film and the adhesive film is a value in a range from 80 μm to 110 μm.

4. A method of manufacturing a cover sheet package, the method comprising:
preparing a laminated sheet material which has a resin film, an adhesive film, a peeling sheet and a protective sheet;
cutting the protective sheet, the resin film and the adhesive film;
forming an opening by punching the protective sheet, the resin film and the adhesive film in an annular configuration, cutting annular configuration portions thereof away from other portions thereof, and punching the peeling sheet at a center circle of the annular configuration;
forming the resin film and the adhesive film into a cover sheet to be adhered to a disk substrate; and
adhering the peeling sheet to the adhesive film of the cover sheet and the protective sheet to the resin film of the cover sheet so that the relationship AP₁<AP₂ is satisfied when AP₁ indicates an adhesive force for adhering the peeling sheet to the adhesive film of the cover sheet and AP₂ indicates an adhesive force for adhering the protective sheet to the resin film of the cover sheet.

5. A method of manufacturing a cover sheet package according to claim 4, further comprising:
setting the adhesive force AP₁ to a value selected from a range of 5 to 50 (gf/cm); and
setting the adhesive force AP₂ to a value selected from a range of (AP₁×1.0) to (AP₁×3.0).

6. A method of manufacturing a cover sheet package according to claim 5, further comprising:
adjusting a total thickness of the cover sheet, the resin film and the adhesive film to a value in a range from 80 μm to 110 μm.

7. A method of manufacturing a cover sheet package comprising:
preparing a laminated sheet material which has a resin film, an adhesive film, a peeling sheet and a protective sheet;
cutting the resin film, the adhesive film and the peeling sheet;
forming the resin film and the adhesive film into a cover sheet to be adhered to a disk substrate;
forming an opening at a center of the laminated sheet by punching the peeling sheet and the cover sheet in a disk configuration, cutting disk configuration portions thereof away from other portions thereof, and punching the protective sheet at the center of the laminated sheet; and
adhering the peeling sheet to the adhesive film of the cover sheet and the protective sheet to the resin film of the cover sheet so that the relationship AP₁≦AP₂ is satisfied when AP₁ indicates an adhesive force for adhering the peeling sheet to the adhesive film of the cover sheet and AP₂ indicates an adhesive force for adhering the protective sheet to the resin film of the cover sheet.

8. A method of manufacturing a cover sheet package according to claim 7, further comprising:
setting the adhesive force AP₁ to a value selected from a range from 5 to 50 (gf/cm); and
setting the adhesive force AP₂ to a value selected from a range from (AP₁×1.0) to (AP₁×3.0).

9. A method of manufacturing a cover sheet package according to claim 8, further comprising:
adjusting a total thickness of the cover sheet, the in film and the adhesive film to a value in a range from μm to 110 μm.
